(19) United States
(12) Patent Application Publication
(10) Pub. No.: US 2004/0113116 A1
(43) Pub. Date: Jun. 17, 2004

(54) Remote valve actuator

(76) Inventors: Larry R. London, Landsdale, PA (US); Christopher N. Lampitoc, Harleysville, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/300,279

(22) Filed: Nov. 20, 2002

(51) Int. Cl. F16K 31/00

(52) U.S. Cl. 251/294

(57) ABSTRACT

A remote valve actuator for transmitting rotational motion to a remotely located valve is provided. The remote valve actuator includes a drive wheel, a driven wheel, and a drive cable entrained about the drive wheel and the driven wheel so that rotational motion of the drive wheel translates the drive cable and drives the driven wheel to effect actuation of the valve. The remote valve actuator includes a coupler for connecting the two ends of the cable to one another. The coupler is configured to connect the cable ends to one another without creating stress points proximate the cable ends as the coupler rides over the drive and driven wheels.

### FIELD OF THE INVENTION

The present invention relates generally to a system for remotely actuating a valve, and in particular, but not exclusively, to a system for mechanically transferring rotational motion of a drive wheel to a remotely located valve using a cable having ends that are connected with a coupler that is configured to substantially prevent fatigue failure of the cable at the coupler as the coupler rides over the drive wheel.

### BACKGROUND OF THE INVENTION

Presently, many applications exist in which remote actuation of a valve is desirable. For example, in many complex systems, such as nautical vessels, numerous valves may be required, a number of which may need to be provided at locations which an operator cannot reach. In addition, in certain applications a valve may be located in a hazardous environment, such as a radioactive environment, which an operator may not safely enter. In still other applications, a valve may be located at a position that is inconvenient for an operator to reach, such as beyond reach above ground, as is typically found in a chemical or petroleum plant. In many of these applications, it is desirable to provide a remote valve actuator that includes a cable loop for transferring rotational motion supplied by an operator to the remotely located valve. However, despite the advantages remote valve actuators may provide, adoption of remote valve actuators has been impeded in numerous applications for many years due to continuing deficiencies of presently available systems.

In many applications, in order to provide a cost effective installation, it is necessary that an installer be able to create a cable loop having the needed length at the installation site, rather than place a custom order for a specified cable length with the manufacturer. To this end, a coupler is needed which permits the installer to terminate the two ends of a cable at the installation site to create a cable loop of a desired length. At the same time, many of these applications involve actuation of a valve that requires a large number of revolutions compared with the desired length of the cable loop. In this regard, it is not uncommon to require that the cable loop complete many circuits of travel about the system to create the needed valve rotation.

However, existing couplers that permit in-field termination of the cable are incapable of reliably and durably completing full circuits of travel about the system. In some cases, the coupler causes system failure by jamming as the coupler rides over the drive wheel that drives the cable loop. In other cases, the inability of the coupler to negotiate the bend around the drive wheel, causes the cable loop to disengage from the drive wheel, causing system failure. Still further, couplers that are presently available include rigid sleeves that surround the cable at the cable ends, thus creating rigid cable end portions. The rigid cable end portions resist bending as the cable negotiates the drive wheel, which creates stress concentration points at the rigid cable end portions. The repeated use of such a system causes cable fatigue at the stress concentration points, which inevitably leads to cable failure. Thus, present remote valve actuators, having cables that may be terminated in the field, may not be reliably operated with the cable loop traversing a complete circuit about the system. Instead, to accommodate a valve which requires many revolutions, the length of the cable loop must be increased so that the coupler completes the required range of travel without encountering the wheels of the system. In many instances, this necessitates excessive cable length, which is highly undesirable or unacceptable in many applications.

Accordingly, a long felt need in the art remains for a coupler that is capable of repeatedly, reliably, and durably traveling about a complete circuit of a remote valve actuator, which includes riding over the wheels of the system.

### SUMMARY OF THE INVENTION

In accordance with the present invention, a remote valve actuator is provided for transmitting rotational motion supplied at an input location to a remotely located valve. The remote valve actuator includes a drive wheel for receiving a supplied rotational motion that may be transmitted to a valve to effect actuation of the valve. The drive wheel includes a plurality of teeth disposed at the periphery of the drive wheel. The remote valve actuator also includes a driven wheel for receiving the rotational motion supplied to the drive wheel. The driven wheel is configured to be connected to the valve so that rotational motion of the driven wheel effects actuation of the valve. The driven wheel also includes a plurality of teeth disposed at the periphery of the driven wheel. The valve actuator further includes a drive cable for transmitting rotational motion of the drive wheel to the driven wheel. The drive cable has a plurality of radial protrusions for meshing engagement with the teeth of the drive and driven wheels to promote movement of the drive cable relative to the drive and driven wheels.

In addition, the remote valve actuator includes a coupler for connecting the two ends of the cable to one another. The coupler is configured to connect the cable ends to one another without creating stress concentration points proximate the cable ends. Stress concentration points create fatigue in the drive cable as the coupler rides over the drive and driven wheels which causes the drive cable to fail at the stress concentration points. Accordingly, the coupler is configured to permit the cable ends to pivot or swivel relative to one another within the coupler along one or more selected directions. The pivot or swivel motion allows the drive cable to conform to the shape of the drive and driven wheels while substantially preventing stress concentration at the coupled cable ends. For example, each end of the cable may independently pivot within the coupler along a direction parallel to the plane of the drive wheel. The drive cable forms a continuous loop for entrainment about the drive wheel and the driven wheel so that rotational motion of the drive wheel produces translational motion of the drive cable, that, in turn, produces rotational movement of the driven wheel to effect actuation of the valve.

In an exemplary embodiment of the coupler, the coupler includes a ball swaged onto each end of the cable. The coupler further includes a coupler housing for rotatably retaining the swaged balls therein, so that the cable ends are free to rotate within the housing about the longitudinal axis of the cable and are free to pivot within the housing along a direction orthogonal to the longitudinal axis of the cable.

### BRIEF DESCRIPTION OF THE DRAWINGS

The foregoing summary and the following detailed description of the preferred embodiments of the present invention will be best understood when read in conjunction with the appended drawings, in which:

FIG. 1 schematically illustrates a perspective view of a remote valve actuator in accordance with the present invention;

FIG. 2 schematically illustrates a side elevational view of the remote valve actuator of FIG. 1, but with the housing and conduit not shown to reveal the cooperation among the gearing, drive and driven wheels, and the drive cable;

FIG. 3 schematically illustrates a cross-sectional view taken along the line 3-3 of FIG. 1;

FIG. 4 schematically illustrates a cross-sectional view taken along the line 4-4 of FIG. 1;

FIG. 5 schematically illustrates a side elevational view of a coupler in accordance with the present invention for connecting the two ends of the drive cable to form an drive cable loop in which the two cable ends may swivel relative to one another in such a manner so as to substantially prevent fatigue failure at the cable ends as the coupler rides over the drive and driven wheels; and

FIG. 6 schematically illustrates that exploded view of the coupler of FIG. 5.

### DETAILED DESCRIPTION OF THE INVENTION

Referring to the figures, wherein like reference numerals refer to like elements throughout, a remote valve actuator in accordance with the present invention, generally designated 200, is illustrated. The remote valve actuator 200 includes a drive cable 90, provided in the form of a continuous loop, for transferring rotational motion from a drive wheel 40 to a driven wheel 50, so that a valve connected to the driven wheel 50 may be actuated in response to rotational motion of the driven wheel 50. In particular, the two ends 96, 98 of the drive cable 90 are connected to one another by a coupler 100 that is configured to ride over the drive and driven wheels 40, 50. Moreover, the structure of the coupler 100 connects the cable ends 96, 98 to one another without creating stress points proximate the cable ends 96, 98 that would fatigue the drive cable 90 and cause the drive cable 90 to fail as the coupler 100 rides over the drive and driven wheels 40, 50. In this regard, the coupler 100 permits the cable ends 96, 98 to pivot or swivel relative to one another along one or more selected directions so as to allow the drive cable 90 to conform to the shape of the drive and driven wheels 40, 50 while substantially preventing stress concentration at the coupled cable ends 96, 98. In other words, unlike crimped sleeve(s) that may be provided to connect one cable end to the other and thus create a rigid cable portion at the sleeve(s), the coupler 100 of the present invention does not create rigid cable portions that resist bending. Therefore, the coupler 100 of the present invention does not create stress concentration points that would cause the cable to fatigue and fail upon repeated use. To the contrary, as provided in an exemplary embodiment of the invention illustrated herein, the coupler 100 includes a housing 104 and includes a ball 102 swaged onto each cable end 96, 98. The balls 102 are rotatably retained within the housing 104 to permit the two cable ends 96, 98 to pivot or swivel a sufficient amount so as to substantially prevent cable fatigue at the coupler 100 as the coupler 100 rides over the drive and driven wheels 40, 50.

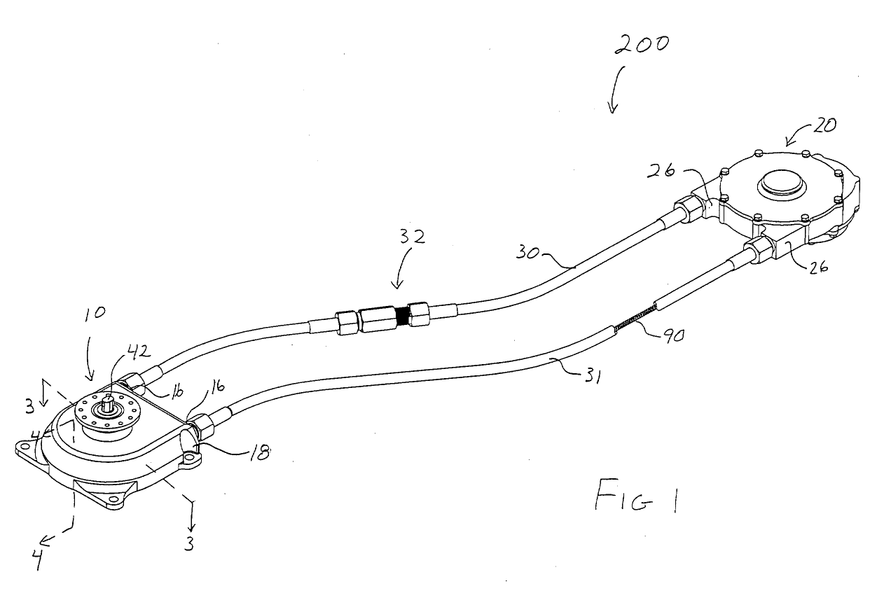

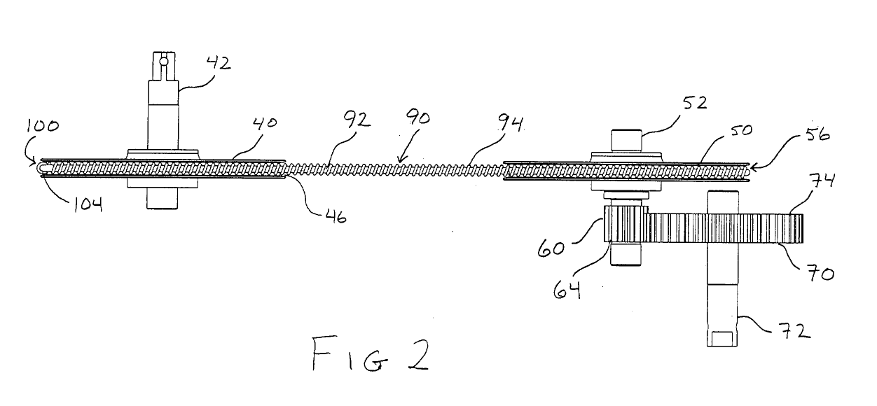

Turning now to FIGS. 1 and 2, in particular, a remote valve actuator 200 in accordance with the present invention is illustrated. The remote valve actuator 200 includes a drive wheel housing 10 that may be located at a desired position where a driving force is to be supplied to the remote valve actuator 200 for the purpose of effecting actuation of a valve. The drive wheel housing 10 may conveniently include a drive housing baseplate 14 and a drive housing cover 18 for closure onto the baseplate 14 to provide a drive wheel cavity between the baseplate 14 and the drive housing cover 18 for rotatably supporting a drive wheel 40 therein.

Similarly, the remote valve actuator 200 includes a driven wheel housing 20 for location at a position remotely located relative to the drive wheel housing 10 and proximately located to the valve that is to be actuated by the remote valve actuator 200. The driven wheel housing 20 includes a cavity disposed therein for rotatably supporting a driven wheel 50, along with optional torque-increasing gearing 60, 70. The drive wheel housing 10 and the driven wheel housing 20 each respectively include a drive cable port 16, 26 that provides openings in the housings 10, 20 through which a drive cable 90 may pass.

The remote valve actuator 200 also includes two cable conduits 30, 31 connected between the ports 16, 26 to provide a continuous looped cable pathway between the drive wheel housing and driven wheel housing 20 in which the drive cable 90 may be slidably disposed. One or both of the cable conduits 30, 31 may optionally include a cable access port 32 which permits access to the cable 90. Both the drive cable 90 and the cable conduits 30, 31 may comprise flexible materials that permit the drive cable 90 and the cable conduits 30, 31 to be bent. In particular, the drive cable 90 and the cable conduits 30, 31 may comprise flexible materials the permit the drive cable 90 and the cable conduits 30, 31 to be bent along two different planes that are oriented orthogonal to one another. For example, the conduits 30, 31 may include four layers of material in the form of concentric tubes. The innermost layer may include a polytetraflouroethylene liner; the second innermost layer may include high tensile strength steel wires wrapped around the liner; the third innermost layer may include a cross wrap of steel wires; and the outermost layer may include a polytetraflouroethylene jacket.

Turning now more particularly to FIGS. 2-4, the configuration of the drive cable 90 and the drive and driven wheels 40, 50, and the cooperation therebetween, is shown. The drive wheel 40 is rotatably mounted on a drive shaft 42 which may be rotatably supported within the drive housing 10 by one or more sets of bearings, such as ball bearings. The drive shaft 42 is locked into position relative to the drive wheel 40, for example, by a woodruff key 49, so that rotational force provided to the drive shaft creates rotational motion of the drive wheel 40. The rotational force may be provided via a hand wheel attached to the drive shaft 42. The drive wheel 40 includes a plurality of drive teeth 44 provided at the periphery of the drive wheel 40 and extending around the drive wheel 40 at equally spaced intervals. The drive teeth may take the form of protrusions extending radially out from the drive wheel 40. Alternatively, the drive teeth 44 may take the form of depressions extending radially into the drive wheel 40. For example, the drive teeth 44 may be hobs that are formed into the drive wheel 40.

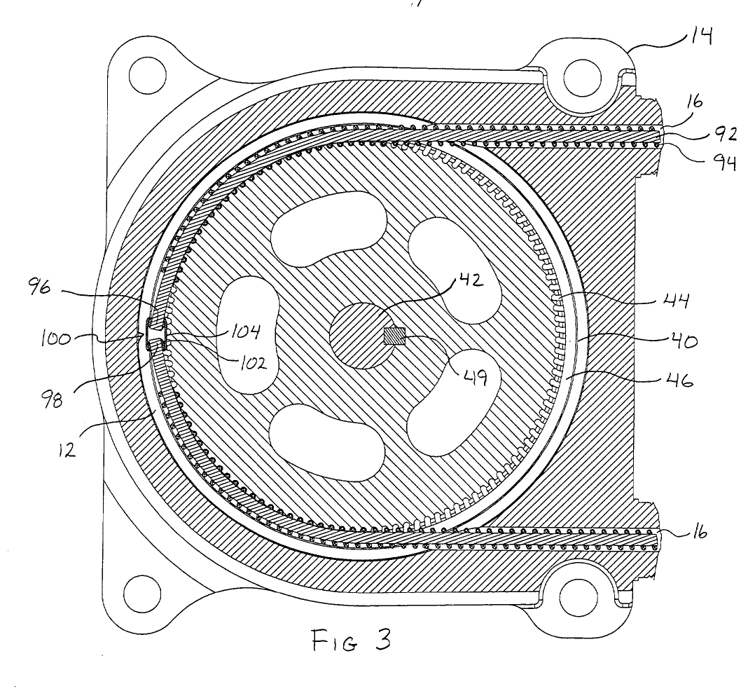

The drive wheel 40 may desirably include a cable groove 46 extending radially into the drive wheel 40 circularly about the periphery of the drive wheel 40 for receiving the drive cable 90 and for guiding the motion of the drive cable 90 therein. The cable groove 46 may have a semicircular cross-sectional shape, or may have any other shape suited to receiving the drive cable 90 therein. As illustrated in FIG. 3, the drive teeth 44, e.g., hobs, may be provided within the cable groove 46 at the most radially inward portion of the cable groove 46.

In a similar manner the driven wheel 50 is rotatably mounted on a driven wheel shaft 52 which may be rotatably supported within the driven wheel housing 20 by one or more sets of bearings, such as ball bearings. The driven wheel shaft 52 is locked into position relative to the driven wheel 50, such as by a woodruff key, so that rotation of the driven wheel 50 rotates the driven wheel shaft 52. The driven wheel 50 includes a plurality of teeth similar in configuration to those of the drive wheel 40. The driven wheel 50 may desirably include a cable groove 56 extending radially into the driven wheel 50 circularly about the periphery of the driven wheel 50 for receiving the drive cable 90 and for guiding the motion of the drive cable 90 therein. The teeth of the driven wheel 50 may be provided within the cable groove 56 in a similar fashion to the drive wheel 40.

A pinion gear 60 may be mounted on the driven wheel shaft 52 so that the pinion gear 60 rotates in tandem with the driven wheel 50. The pinion gear 60 includes teeth 64 in meshing engagement with teeth 74 of a spur gear 70 so that rotation of the pinion gear 60 causes rotation of the spur gear 70. The spur gear 70 is mounted on a spur gear shaft 72 that is provided for connection, directly or indirectly, to the valve to be actuated, so that rotation of the spur gear shaft 72 effects actuation of the valve. The ratios of the diameters of the driven wheel 50, the pinion gear 60, and the spur gear 70 may be selected so as to provide increased torque at the spur gear shaft 72 compared to the torque at the driven wheel shaft 52. For example, the driven wheel 50 may have a 6 inch diameter, the pinion gear 60 may have a 1 inch diameter, and the spur gear 70 may have a 4 inch diameter.

The drive cable 90 includes a flexible cable core 92 having two ends 96, 98 that are connected to one another by a coupler 100 to provide a continuous loop. The cable core 92 has a longitudinal axis that extends along the length of the cable core 92 through a central portion of the cable core. The longitudinal axis may take on a curved shape as the cable core 22 is bent; for example, the longitudinal axis may take on a semicircular shape where the cable core 92 rides over the drive and driven wheels 40, 50.

The drive cable 90 includes a series of equally spaced protrusions 94 which are configured for meshing engagement with the teeth 44 of the drive wheel 40 and the teeth of the driven wheel 50 so that rotational motion of the drive wheel 40 imparts translational motion to the drive cable 90, which in turn causes rotational motion of the driven wheel 50. The diameter of the drive wheel 40 and the driven wheel 50 should be sufficiently large to provide a desired degree of engagement between the drive cable 90 and the drive and driven wheels 40, 50 to promote cooperation therebetween. In addition, the drive and driven wheels 40, 50 may be substantially similar in size, since any needed additional torque for actuating the valve may be produced using the pinion gear 60 and a spur gear 70. In addition, providing drive and driven wheels 40, 50 of larger size, reduces frictional losses in the system compared with smaller size wheels 40, 50, due to a decrease in drive cable tension. The length of the drive cable 90 is selected with regard to the distance between the drive wheel 40 and the driven wheel 50 so that sufficient tension is present in the drive cable 90 to maintain the drive cable engagement with the drive and driven wheels 40, 50.

The cable core 92 may comprise a plurality of long metal lay wires wrapped in helical fashion. The protrusions 94 may be provided by individual annular rings that are spaced along the length of the cable core 92 at a pitch matched to the spacing of the drive teeth 44 of the drive wheel 40, as well as the teeth of the driven wheel 50. Alternatively, the protrusions 94 may comprise a continuous helix formed by wrapping the cable core 92 with a helical wire in a configuration for meshing engagement with teeth 44, formed, for example, as hobs in the drive wheel 40, as well as the hobs of the driven wheel 50.

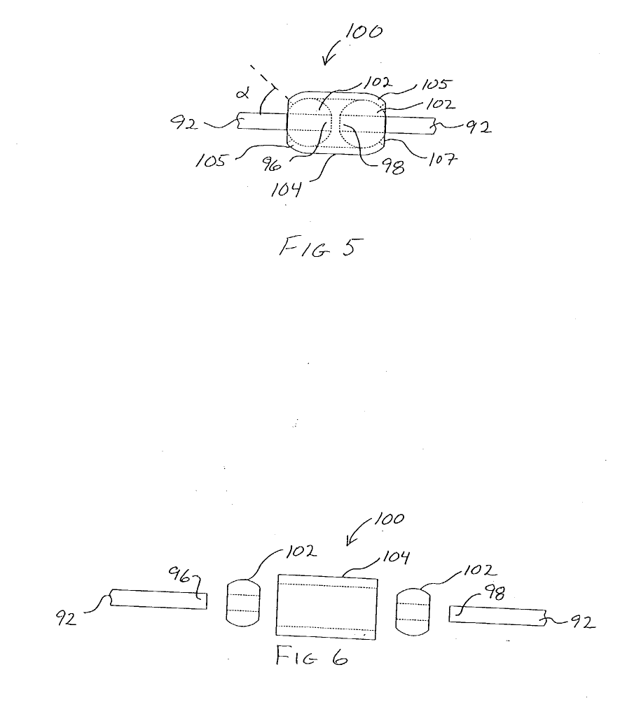

Referring now to FIGS. 3-6, and in particular FIGS. 5 and 6, a configuration of a coupler 100 for connecting the two cable ends 96, 98 in accordance with the present invention is illustrated. The coupler 100 includes two cable terminations 102 disposed at the cable ends 96, 98. The cable terminations 102 may be provided as balls that are swaged onto the ends 96, 98 of the cable core 92 to form spherical terminations 102. In such a configuration, it may be desirable not to provide protrusions 94 at the attachment site of the cable terminations 102. The coupler 100 further includes a coupler housing 104 which may be provided in the form of a cylindrical sleeve into which the cable terminations 102 are disposed. With the cable terminations 102 located inside the coupler housing 104, the housing 104 may be crimped at each end to provide housing shoulders 105 that rotatably retain the cable terminations 102 within the coupler housing 104.

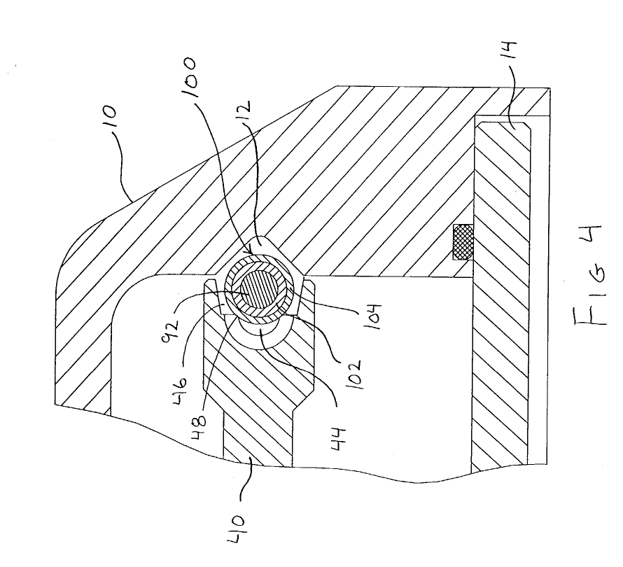

The spherical cable terminations 102 permit each cable end 96, 98 to rotate within the coupler housing 104 about the longitudinal axis of the cable core 92. The cable ends 96, 98 retained within the cable terminations 102 remain straight within the coupler housing 104 as the coupler 100 rides over the drive and driven wheels 40, 50. In addition, the spherical cable terminations 102 permit each cable end 96, 98 to pivot through a selected angle, α, relative a longitudinal axis of the coupler housing 104 so that the drive cable 90 may generally conform to the radius of the drive wheel 40 and the driven wheel 50 as the coupler 100 rides over the drive and the driven wheels 40, 50, as shown in FIG. 3. In this regard, the cable groove 46 is dimensioned to receive the coupler housing 104 and may be provided with shoulders 48 on which the coupler housing 104 may be supported, as shown in FIG. 4. In addition, the drive wheel housing 10 (as well as the driven wheel housing 20) may include a groove 12 for accommodating the height of the coupler 100 to provide clearance for the coupler 100 to pass through the drive wheel housing 10. The selected angle, α, is chosen with regard to the size of balls 102, length of coupler housing 104, and the diameter of the drive and driven wheels 40, 50, with a smaller diameter wheel requiring a larger selected angle to permit conformity of the drive cable shape at the coupler 100 with the drive and driven wheels 40, 50. For example, for a 6 inch diameter drive wheel 40, a selected angle, α, of 20° may be sufficient. In addition, the ability of each cable end 96, 98 to pivot and to rotate can aid the drive cable 90 in traversing bends that may be encountered in the conduits 30, 31. Further, rotation of each cable end 96, 98 may be particularly useful for the helical protrusion 94 configuration, since the portion of the helical protrusion 94 proximate a cable end 96, 98 may need to rotate into registration with the teeth 44 of the drive wheel 40 (or driven wheel 50) as the helical protrusions 94 begin to engage the drive wheel 40 (or driven wheel 50).

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A remote valve actuator for transmitting rotational motion supplied at an input location to a valve remotely located relative to the input location, comprising:
a drive wheel for receiving a supplied rotational motion for transmission to a valve to effect actuation of the valve, the drive wheel comprising a plurality of teeth disposed at the periphery of the drive wheel;
a driven wheel for receiving the rotational motion supplied to the drive wheel, the driven wheel adapted to be connected to the valve so that rotational motion of the driven wheel effects actuation of the valve, the driven wheel comprising a plurality of teeth disposed at the periphery of the driven wheel;
a drive cable for transmitting rotational motion of the drive wheel to the driven wheel, the drive cable having a plurality of radial protrusions for meshing engagement with the teeth of the drive and driven wheels; and
a coupler for connecting the two ends of the cable to one another so that each end of the cable independently pivots within the coupler along a direction parallel to the plane of the drive wheel, whereby the drive cable forms a continuous loop for entrainment about the drive wheel and the driven wheel so that rotational motion of the drive wheel produces translational motion of the drive cable that in turn produces rotational movement of the driven wheel to effect actuation of the valve.

2. The remote valve actuator according to claim 1, wherein the coupler comprises a cable termination provided on each end of the cable, and a coupler housing for retaining the cable terminations therein, so that the cable terminations are free to rotate within the housing about the longitudinal axis of the cable and pivot within the housing along a direction orthogonal to a longitudinal axis of the housing.

3. The remote valve actuator according to claim 2, wherein the cable termination comprises a ball.

4. The remote valve actuator according to claim 1, wherein the coupler is configured to provide sufficient motion of the two cable ends relative to one another within the coupler so as to permit the portions of the cable proximate the two ends to remain substantially in contact with the drive wheel as the coupler rides over the drive wheel.

5. The remote valve actuator according to claim 1, wherein the drive wheel and the driven wheel each comprise a cable groove for receiving the drive cable.

6. The remote valve actuator according to claim 5, wherein the teeth of the drive wheel are disposed within the cable groove of the drive wheel.

7. The remote valve actuator according to claim 5, wherein the coupler is dimensioned to seat substantially within the cable groove of the drive wheel.

8. The remote valve actuator according to claim 5, wherein the teeth of the drive wheel comprise depressions.

9. The remote valve actuator according to claim 1, wherein the drive cable comprises a helical wire wrapped about a cable core, the helical wire providing the radial protrusions on the drive cable.

10. The remote valve actuator according to claim 1, wherein the cable is configured to permit translation of the cable along a curved path that includes bends disposed along two orthogonal directions.

11. A remote valve actuator for transmitting rotational motion supplied at an input location to a valve remotely located relative to the input location, comprising:
a drive wheel housing and a driven wheel housing;
a drive wheel rotatably supported within the drive wheel housing, the drive wheel comprising a plurality of teeth disposed at the periphery of the drive wheel;
a driven wheel rotatably supported within the driven wheel housing for receiving rotational motion supplied to the drive wheel, the driven wheel for connection to a valve so that rotational motion of the driven wheel effects actuation of the valve, the driven wheel comprising a plurality of teeth disposed at the periphery of the driven wheel;
a drive cable for transmitting rotational motion of the drive wheel to the driven wheel, the drive cable having a plurality of radial protrusions for meshing engagement with the teeth of the drive and driven wheels; and
means for coupling the two ends of the cable to one another so that the drive cable forms a continuous loop for transmitting rotational motion of the drive wheel to the driven wheel to effect actuation of the valve, the coupling means configured to permit each end of the cable to independently pivot within the coupling means along a direction parallel to the plane of the drive wheel.

12. The remote valve actuator according to claim 11, wherein the coupling means is configured to permit the cable ends to freely swivel relative to one another along any direction orthogonal to the longitudinal axis of the coupling means.

13. The remote valve actuator according to claim 11, wherein each cable end comprises a termination means for retaining the cable ends in the coupling means.

14. The remote valve actuator according to claim 13, wherein the termination means comprises a ball.

15. The remote valve actuator according to claim 11, wherein the coupling means is configured to provide sufficient motion of the two cable ends relative to one another within the coupling means so as to permit the portions of the cable proximate the two ends to remain substantially in contact with the drive wheel as the coupling means rides over the drive wheel.

16. The remote valve actuator according to claim 11, wherein the drive wheel and the driven wheel each comprise a cable groove for receiving the drive cable.

17. The remote valve actuator according to claim 16, wherein the teeth of the drive wheel are disposed within the cable groove of the drive wheel.

18. The remote valve actuator according to claim 16, wherein the coupling means is dimensioned to seat substantially within the cable groove of the drive wheel.

19. The remote valve actuator according to claim 16, wherein the teeth of the drive wheel comprise depressions.

20. The remote valve actuator according to claim 11, wherein the drive cable comprises a helical wire wrapped about the cable core, the helical wire providing the radial protrusions on the drive cable.

21. The remote valve actuator according to claim 11, wherein the cable is configured to permit translation of the cable along a curved path that includes bends disposed along two orthogonal directions.

22. A remote valve actuator for transmitting rotational motion supplied at an input location to a valve remotely located relative to the input location, comprising:
a drive wheel housing and a driven wheel housing;
a drive wheel rotatably supported within the drive wheel housing, the drive wheel comprising a plurality of teeth disposed at the periphery of the drive wheel;
a driven wheel rotatably supported within the driven wheel housing for receiving rotational motion supplied to the drive wheel, the driven wheel for connection to a valve so that rotational motion of the driven wheel effects actuation of the valve, the driven wheel comprising a plurality of teeth disposed at the periphery of the driven wheel;
a drive cable for transmitting rotational motion of the drive wheel to the driven wheel, the drive cable having a plurality of radial protrusions for meshing engagement with the teeth of the drive and driven wheels; and
means for coupling the two ends of the cable to one another so that the drive cable forms a continuous loop for transmitting rotational motion of the drive wheel to the driven wheel to effect actuation of the valve, the coupling means comprising means for terminating the ends of the cable so that cable end portions of increased rigidity that resist cable bending upon traversing the drive wheel are not created.

23. The remote valve actuator according to claim 22, wherein the coupling means is configured to permit each end of the cable to independently pivot within the coupling means along a direction parallel to the plane of the drive wheel.

24. The remote valve actuator according to claim 23, wherein the coupling means is configured to permit the cable ends to freely swivel relative to one another along any direction orthogonal to the longitudinal axis of the coupling means.

25. The remote valve actuator according to claim 22, wherein each cable end comprises a termination means for retaining the cable ends in the coupling means.

26. The remote valve actuator according to claim 25, wherein the termination means comprises a ball.

27. The remote valve actuator according to claim 22, wherein the coupling means is configured to provide sufficient motion of the two cable ends relative to one another within the coupling means so as to permit the portions of the cable proximate the two ends to remain substantially in contact with the drive wheel as the coupling means rides along the drive wheel.

28. The remote valve actuator according to claim 22, wherein the drive wheel and the driven wheel each comprise a cable groove for receiving the drive cable.

29. The remote valve actuator according to claim 28, wherein the teeth of the drive wheel are disposed within the cable groove of the drive wheel.

30. The remote valve actuator according to claim 28, wherein the coupling means is dimensioned to seat substantially within the cable groove of the drive wheel.

31. The remote valve actuator according to claim 28, wherein the teeth of the drive wheel comprise depressions.

32. The remote valve actuator according to claim 22, wherein the drive cable comprises a helical wire wrapped about the cable core, the helical wire providing the radial protrusions on the drive cable.

33. The remote valve actuator according to claim 22, wherein the cable is configured to permit translation of the cable along a curved path that includes bends disposed along two orthogonal directions.
